(19) United States
(12) Patent Application Publication
(10) Pub. No.: US 2026/0148351 A1
(43) Pub. Date: May 28, 2026

(54) METHOD AND APPARATUS FOR DENOISING RAY TRACING IMAGE

(71) Applicant: SAMSUNG ELECTRONICS CO., LTD., Suwon-si (KR)

(72) Inventors: Nahyup KANG, Suwon-si (KR); Hanjun KIM, Suwon-si (KR); Seokhwan JANG, Suwon-si (KR); Hwiryong JUNG, Suwon-si (KR); Seokpyo HONG, Suwon-si (KR)

(73) Assignee: SAMSUNG ELECTRONICS CO., LTD., Suwon-si (KR)

(21) Appl. No.: 19/252,583

(22) Filed: Jun. 27, 2025

(30) Foreign Application Priority Data
Nov. 28, 2024 (KR) 10-2024-0173416

(51) Int. Cl. G06T 5/70; G06T 3/40; G06T 5/50; G06T 5/60; G06T 15/06

(52) U.S. Cl. CPC G06T 5/70; G06T 3/40; G06T 5/50; G06T 5/60; G06T 15/06; G06T 2207/20081

(57) ABSTRACT

A method of denoising a ray tracing image includes obtaining an irradiance image by receiving a rendering result, by separating the irradiance image for each frequency component, performing downsampling on the separated irradiance image to to obtain a first downsampled irradiance image and a second downsampled irradiance image, obtaining a filter weight using a denoising look-up table (LUT) based on pixel information, the first downsampled irradiance image and the second downsampled irradiance image, obtaining, using the filter weight. a denoised irradiance image by performing a weighted sum on the first downsampled irradiance image and the second downsampled irradiance image, performing upscaling on the denoised irradiance image using an upscaling LUT, and obtaining a final denoised ray tracing image by multiplying a result of the upscaling by an albedo image.

### CROSS-REFERENCE TO RELATED APPLICATION

This application is based on and claims priority from Korean Patent Application No. 10-2024-0173416, filed on Nov. 28, 2024, in the Korean Intellectual Property Office, the disclosure of which is incorporated herein by reference in its entirety.

### BACKGROUND

### 1. Field

Methods and apparatuses of the disclosure relate to denoising a ray tracing image.

### 2. Description of the Related Art

Recently, three-dimensional (3D) graphics technology is widely used in various fields such as movies, games, and virtual reality (VR). In the 3D graphics technology, ray tracing may be used to render an image. For example, ray tracing is rendering technology that implements realistic lighting, reflection, and shadow effects by tracing the path of light for each pixel. However, ray tracing may require a large amount of operation.

Ray tracing accurately calculates the influence of each light source and generates a realistic image, but due to a large amount of calculation, various denoising techniques are applied to an image for a real-time graphics application, allowing a high-quality image to be generated with a small number of samples. Therefore, there is a growing need for technology that may solve the problem of high operation costs in a real-time graphics environment and enable realistic image rendering even in a limited environment, such as a mobile device, thereby expanding the scope of an application in real-time graphics.

### SUMMARY

One or more embodiments may address at least the above problems and/or disadvantages and other disadvantages not described above. Also, the embodiments are not required to overcome the disadvantages described above, and an embodiment may not overcome any of the problems described above.

According to an aspect of the disclosure, there is provided a method of denoising a ray tracing image, the method including: obtaining an irradiance image corresponding to a rendering result; separating the irradiance image into a plurality of separated irradiance images, each of the plurality of separated irradiance images corresponding to a frequency component, among a plurality of frequency component; performing downsampling on the plurality of separated irradiance images to obtain a first downsampled irradiance image and a second downsampled irradiance image; obtaining a filter weight using a denoising look-up table (LUT) based on pixel information, the first downsampled irradiance image and the second downsampled irradiance image; obtaining, using the filter weight, a denoised irradiance image by performing a weighted sum on the first downsampled irradiance image and the second downsampled irradiance image; performing upscaling on the denoised irradiance image using an upscaling LUT to obtain an upscaled irradiance image; and obtaining a final denoised ray tracing image by multiplying the upscaled irradiance image by an albedo image.

The obtaining of the filter weight may include obtaining the filter weight based on a dimension reducer obtained by performing a conversion on a denoising multi-layer perceptron (MLP) that is trained by a ray tracing MLP training method and the denoising LUT obtained by performing the conversion on the denoising MLP that is trained by the ray tracing MLP training method.

The obtaining of the irradiance image may include demodulating a ray tracing image into an albedo image.

The first downsampled irradiance image and the second downsampled irradiance image may be obtained using a method in which a high-frequency component of the irradiance image generates the first downsampled irradiance image using a max-pooling method and a low-frequency component of the irradiance image generates the second downsampled irradiance image using an average-pooling method.

The pixel information may include position map information or normal map information of pixels obtained according to the rendering result.

The obtaining of the denoised irradiance image may include performing an operation on the filter weight for pixels corresponding to operation targets, which are included in the first downsampled image and the second downsampled image, and pixels included in a range around the pixels corresponding to the operation targets.

The rendering result may include at least one of an albedo, a ray tracing image, a position map, and a normal map.

According to another aspect of the disclosure, there is provided a training method of ray tracing denoising, the training method including: obtaining a first irradiance image corresponding to a rendering result; separating the first irradiance image into a plurality of separated first irradiance images, each of the plurality of separated first irradiance images corresponding to a frequency component, among a plurality of frequency component; performing downsampling on the plurality of separated first irradiance images to obtain a first downsampled irradiance image and a second downsampled irradiance image; obtaining parameters from a denoising multi-layer perceptron (MLP) based on pixel information, the first downsampled irradiance image and the second downsampled irradiance image; obtaining, using the parameters, a second irradiance image that is denoised by performing a weighted sum on the first downsampled irradiance image and the second downsampled irradiance image; and training the denoising MLP using the second irradiance image.

The obtaining of the first irradiance image may include demodulating a ray tracing image into an albedo image.

The first downsampled irradiance image and the second downsampled irradiance image may be obtained using a method in which a high-frequency component of the first irradiance image generates the first downsampled irradiance image using a max-pooling method and a low-frequency component of the first irradiance image generates the second downsampled irradiance image using an average-pooling method.

The denoising MLP may include a feature bottleneck layer in an intermediate layer.

The obtaining of the second irradiance image may include performing an operation on the parameters corresponding to a filter weight for pixels corresponding to operation targets, which are included in the first downsampled image and the second downsampled image, and pixels included in a range around the pixels corresponding to the operation targets.

The training method may further include obtaining, using an upscaling MLP, a third irradiance image by converting the second irradiance image into a scale of the first irradiance image; and obtaining a denoised ray tracing image by multiplying the third irradiance image by an albedo image.

The training of the denoising MLP using the second irradiance image may include training the denoising MLP based on the denoised ray tracing image.

The training method may further include, based on a completion of training of a filter weight by the denoising MLP, dividing the denoising MLP, converting the divided denoising MLP into a dimension reducer and a denoising look-up table (LUT), and storing the dimension reducer and the denoising LUT.

The dimension reducer may be configured to reduce a dimension of an input to correspond to the denoising LUT, and the denoising LUT may be configured to store a quantized filter weight and output a filter weight of a pixel corresponding to an operation target.

The training method may further include training the upscaling MLP based on the denoised ray tracing image; and converting the upscaling MLP into an upscaling look-up table (LUT) based on a completion of training of the upscaling MLP and storing the upscaling LUT.

According to another aspect of the disclosure, there is provided an electronic device including: a memory configured to store instructions; and one or more processors, wherein, when executed by the one or more processors, the instructions are configured to cause the electronic device to: obtain an irradiance image corresponding to a rendering result; separate the irradiance image into a plurality of separated irradiance images, each of the plurality of separated irradiance images corresponding to a frequency component, among a plurality of frequency component; perform downsampling on the plurality of separated irradiance images to obtain a first downsampled irradiance image and a second downsampled irradiance image; obtain a filter weight using a denoising look-up table (LUT) based on pixel information, the first downsampled irradiance image and the second downsampled irradiance image; obtain, using the filter weight, a denoised irradiance image by performing a weighted sum on the first downsampled irradiance image and the second downsampled irradiance image; perform upscaling on the denoised irradiance image using an upscaling LUT to obtain an upscaled irradiance image; and obtain a final denoised ray tracing image by multiplying the upscaled irradiance image by an albedo image.

The electronic device, wherein, when executed by the one or more processors, the instructions are further configured to cause the electronic device to obtain the filter weight based on a dimension reducer obtained by performing a conversion on a denoising multi-layer perceptron (MLP) that is trained by a ray tracing MLP training method and the denoising LUT obtained by performing the conversion on the denoising MLP that is trained by the ray tracing MLP training method.

### BRIEF DESCRIPTION OF THE DRAWINGS

The above and/or other aspects will be more apparent by describing certain embodiments, taken in conjunction with the accompanying drawings, in which:

FIG. 1 is a flowchart illustrating a training method of a ray tracing denoising multi-layer perceptron (MLP), according to an embodiment;

FIG. 2 is a block diagram schematically illustrating a ray tracing denoising MLP trainer, according to an embodiment;

FIG. 3A is a schematic block diagram illustrating an operation of a denoising MLP, according to an embodiment;

FIG. 3B is a diagram illustrating a process in which a denoising MLP in which training is completed is divided into a dimension reducer and a denoising look-up table (LUT) and stored, according to an embodiment;

FIG. 4 is a block diagram schematically illustrating an operation of an upscaling MLP in which training is completed, according to an embodiment;

FIG. 5 is a diagram illustrating a process of decomposing an input image into intrinsic images, according to an embodiment;

FIG. 6 is a flowchart illustrating a method of denoising a ray tracing image, according to an embodiment;

FIG. 7 is a block diagram schematically illustrating an apparatus for denoising a ray tracing image, according to an embodiment; and

FIG. 8 is a block diagram illustrating an electronic device according to an embodiment.

### DETAILED DESCRIPTION

The following detailed structural or functional description is provided as an example only and various alterations and modifications may be made to embodiments. Accordingly, the embodiments are not to be construed as limited to the disclosure and should be understood to include all changes, equivalents, or replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

Unless otherwise defined, all terms used herein including technical or scientific terms have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

The embodiments may be implemented as various types of products, such as, for example, a personal computer (PC), a laptop computer, a tablet computer, a smartphone, a television (TV), a smart home appliance, an intelligent vehicle, a kiosk, and a wearable device. Hereinafter, embodiments will be described in detail with reference to the accompanying drawings. When describing the embodiments with reference to the accompanying drawings, like reference numerals refer to like elements and a repeated description related thereto will be omitted.

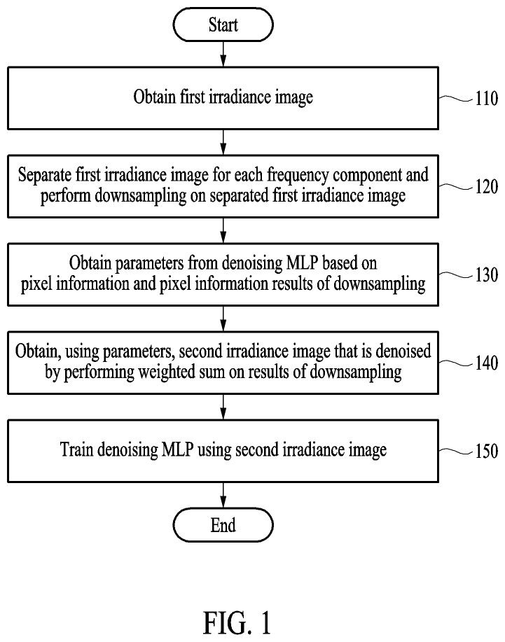

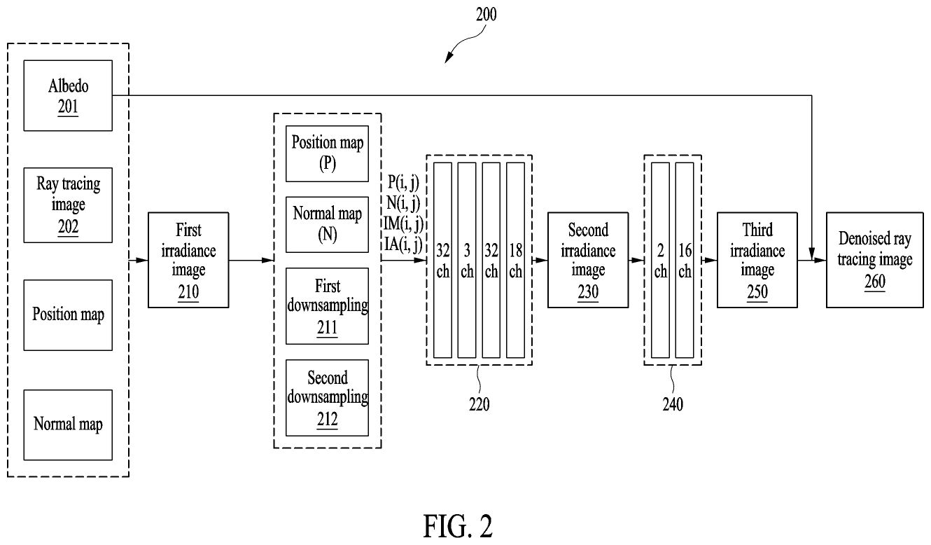

FIG. 1 is a flowchart illustrating a training method of a ray tracing denoising multi-layer perceptron (MLP), according to an embodiment. FIG. 2 is a block diagram schematically illustrating a ray tracing denoising MLP trainer, according to an embodiment.

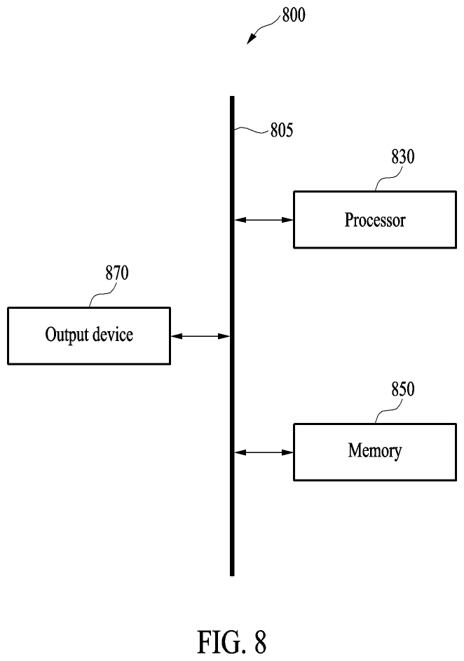

For ease of description, operations 110 to 150 illustrated in FIG. 1 are described as being performed using an electronic device 800 illustrated in FIG. 8. However, operations 110 to 150 may be performed by another suitable electronic device in any suitable system.

Furthermore, the operations of FIG. 1 may be performed in the shown order and manner. However, the order of some operations may change, or some operations may be omitted without departing from the spirit and scope of the shown embodiment. The operations shown in FIG. 1 may be performed in parallel or simultaneously.

In FIG. 2, one or more blocks and a combination thereof may be implemented by a special-purpose hardware-based computer that performs a predetermined function, or a combination of computer instructions and special-purpose hardware. For example, the special-purpose hardware may include, but is not limited to, a central processing unit (CPU), a graphics processing unit (GPU), a neural network processing unit (NPU), a microprocessor, a processor core, a multi-core processor, a multiprocessor, an application-specific integrated circuit (ASIC), and a field-programmable gate array (FPGA).

Referring to FIGS. 1, 2 and 8, according to an embodiment, the electronic device 800 may implement a ray tracing denoising MLP trainer 200 and train a denoising MLP 220 or an upscaling MLP 240.

In operation 110, the method may include obtaining a first irradiance image 210. For example, the electronic device 800 may receive a rendering result and obtain the first irradiance image 210 based on the rendering result. For example, the rendering result may include information related to an image to be rendered. The rendering result may be generated by an external device, but the disclosure is not limited thereto. For example, the rendering result may include, but is not limited to, at least one of an albedo 201, a ray tracing image 202, a position map, and a normal map.

According to an embodiment, an irradiance image may be an image representing an amount of light reaching a certain surface. The irradiance image may be generated by calculating the irradiance received by a surface for each pixel and may be used to express a realistic illumination effect during a rendering process. In this manner, a more natural image may be generated by accurately reflecting the distribution and intensity of light. For example, a scene may be expressed realistically by clearly expressing the difference between a part where light touches strongly and a part where light does not.

The albedo 201 is an image representing the reflectivity of a surface and may include only color information of an object. The albedo 201 may refer to the original color without color distortion occurring in the interaction with light. For example, an image of the albedo 201 of a red object may simply be a texture formed of only red color.

The ray tracing image 202 may be an image including realistic illumination, shadow, and reflection information obtained by tracing a ray. The ray tracing image 202 may be generated based on a method in which light interacts with an object in an actual scene.

The position map may include three-dimensional (3D) spatial coordinate information of each pixel. The position map may provide position information of a pixel included in the rendering result.

The normal map may include normal vector information of a surface and may express fine surface details of an object when calculating illumination. The normal map may make a flat (or an even) surface appear like an uneven texture or express boundaries between objects.

According to an embodiment, the electronic device 800 may demodulate the ray tracing image 202 into the image of the albedo 201.

The electronic device 800 may separate the irradiance and surface color from the ray tracing image 202 through demodulation. For example, electronic device 800 may separate the irradiance and surface color from the ray tracing image 202 through division of the ray tracing image 202 into the image of the albedo 201. For example, in a case in which multiple light sources illuminate a certain object simultaneously, the color information of a surface and the influence of light may be individually analyzed through demodulation.

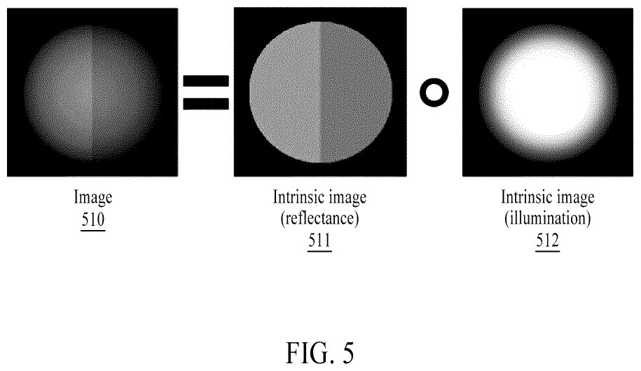

The first irradiance image 210 may represent the distribution of light and may be used for denoising processing. The first irradiance image 210 may be described in detail below with reference to FIG. 5.

In operation 120, the method may include separating the first irradiance image 210 into a plurality of separated first irradiance images and performing downsampling on the plurality of separated first irradiance images. For example, the electronic device 800 may separate the first irradiance image 210 into a plurality of separated first irradiance images corresponding to each of the plurality of frequency components and perform downsampling on the plurality of separated first irradiance images. The electronic device 800 may perform the downsampling according to a predetermined method. For example, the electronic device 800 may separate the first irradiance image 210 into a first separated first irradiance image corresponding to a first frequency component and a second separated first irradiance image corresponding to a second frequency component. The electronic device 800 may obtain a first downsampled image 211 by perform downsampling on the first separated first irradiance image and obtain a second downsampled image 212 by perform downsampling on the second separated first irradiance image. For example, the first frequency component may be high-frequency component of the first irradiance image and the second frequency component may be low-frequency component of the first irradiance image.

According to an embodiment, the predetermined method may be a method in which a high-frequency component of the first irradiance image 210 generates the first downsampled image 211 using a max-pooling method and a low-frequency component of the first irradiance image 210 generates the second downsampled image 212 using an average-pooling method. The first downsampled image 211 may be referred to as a result of the first downsampling or first downsampled information and the second downsampled image 212 may be referred to as a result of the second downsampling or second downsampled information.

According to an embodiment, filtering may be performed sufficiently even with a small receptive field by performing downsampling on the first irradiance image 210. According to an embodiment, the small receptive field may refer to a localized area around a pixel. For example, the small receptive field may be a 3×3 pixel region, but the disclosure is not limited thereto. According to an embodiment, the method may include downsampling the input irradiance image by separating frequency components, dividing high-frequency and low-frequency components through max-pooling and average-pooling, respectively, to preserve salient features of each component, and performing a weighted sum filtering within a small surrounding area (e.g., a 3×3 region). In this manner, according to an embodiment of the disclosure, effective filtering can be achieved without relying on a large convolutional receptive field, but instead within a narrow area around 3×3 pixels. Accordingly, this structure allows for maintaining denoising performance even with a small receptive field, while significantly reducing the computational cost. For example, the first irradiance image 210 may be divided into high-frequency irradiance sampling and low-frequency irradiance sampling, so two types of results on which downsampling is performed in two ways may be generated. Downsampling may be used to reduce the amount of operation while preserving the saliency feature of the first irradiance image 210.

According to an embodiment, high-frequency irradiance sampling may generate the first downsampled image 211 (e.g., IR_MAX_POOL) by performing downsampling on the first irradiance image 210 that is input by a desired ratio through max pooling. The desired ratio may include, but is not limited to, ¼ to ⅛. In this process, important components of the specular irradiance may be stored in the first downsampled image 211 on which max pooling is performed. For example, light reflection or sharp outlines may be stored in the first downsampled image 211.

According to an embodiment, low-frequency irradiance sampling may generate the second downsampled image 212 (e.g., IR_AVG_POOL) by performing downsampling on the first irradiance image 210 that is input by the same ratio through average pooling. In this process, components of the diffuse irradiance may be stored in the second downsampled image 212 on which average pooling is performed. For example, information of an area where light spreads smoothly may be stored in the second downsampled image 212.

In operation 130, the method may include obtaining parameters for denoise MLP based on pixel information and the results from downsampling. For example, the electronic device 800 may obtain parameters from the denoising MLP 220 based on pixel information and the results of downsampling.

According to an embodiment, the pixel information may include position map information and/or normal map information of pixels obtained according to the rendering result.

The denoising MLP 220 may receive, as inputs, the result of the downsampling (e.g., the first downsampled image 211 and the second downsampled image 212), position information P(i, j) and normal information N(i, j) of pixels corresponding to operation targets and may predict parameters. For example, the denoising MLP 220 may predict 18 parameters in a 3×3 range around the pixels corresponding to the operation targets. Accordingly, denoising may be performed based on surrounding information of each pixel. For example, a filter weight to be used for a weighted sum of red, green, and blue (RGB) values of IR_MAX_POOL and IR_AVG_POOL may be output in the surrounding 3×3 pixel range.

According to an embodiment, the denoising MLP 220 may include a feature bottleneck layer in an intermediate layer. For example, the feature bottleneck layer may be 3 channel layer in the denoising MLP 220.

In the intermediate layer of the denoising MLP 220, the feature bottleneck may compress input data, leave only important features (e.g., important information), and remove unnecessary information. Accordingly, the amount of operation of a model may be reduced and training efficiency may increase.

In the denoising MLP 220, the feature bottleneck layer may compress input high-dimensional data into low-dimensional data and extract only information necessary for filtering. For example, the information necessary for filtering may be referred to as important information, but the disclosure is not limited thereto. According to an embodiment, the important information may include, but is not limited to, pixel-wise features and irradiance intensity components corresponding to high and low frequencies. For example, the pixel-wise features may include, but is not limited to, the 3D position and surface normal information (e.g., position map and normal map). For example the irradiance intensity components may include, but is not limited to, IR_MAX_POOL and IR_AVG_POOL. According to an embodiment, accurate filter weights may be generated during the denoising process based on the important information. For example, the feature bottleneck layer may compress 12-dimensional input data into 2 or 3 dimensions, thereby increasing operation efficiency.

In operation 140, the method may include obtaining a second irradiance image 230 based on the parameters. For example, the electronic device 800 may obtain, using the parameters, a second irradiance image 230 that is denoised by performing a weighted sum on the results of the downsampling. The second irradiance image 230 may be an irradiance image from which noise is removed in a down-sampled state.

According to an embodiment, the electronic device 800 may perform an operation on the parameters corresponding to a filter weight for pixels corresponding to the operation targets, which are included in the first downsampled image 211 and the second downsampled image 212, and pixels included in a predetermined range around the pixels corresponding to the operation targets. For example, the smooth second irradiance image 230 from which noise is removed may be generated by performing a weighted sum on the parameters and the RGB values of the first downsampled image 211 (e.g., IR_MAX_POOL) and the second downsampled image 212 (e.g., IR_AVG_POOL) in the 3×3 range around a certain pixel.

In operation 150, the method may include training denoising MLP using second irradiance image. For example, the electronic device 800 may train the denoising MLP 220 using the second irradiance image 230.

According to an embodiment, the electronic device 800 may obtain, using the upscaling MLP 240, a third irradiance image 250 by converting the second irradiance image 230 into a scale of the first irradiance image 210. For example, the third irradiance image 250 may be an upscaled irradiance image obtained using the upscaling MLP 240. The electronic device 800 may obtain a denoised ray tracing image 260 by multiplying the third irradiance image 250 by the image of the albedo 201.

According to an embodiment, the electronic device 800 may train the denoising MLP 220 based on the denoised ray tracing image 260.

In an example case in which the denoising MLP 220 completes training of a filter weight, the electronic device 800 may divide the denoising MLP 220, convert the divided denoising MLP 220 into a dimension reducer and a denoising look-up table (LUT), and store the dimension reducer and the denoising LUT.

According to an embodiment, the dimension reducer may reduce the dimension of an input to correspond to a denoising LUT, and the denoising LUT may store a quantized filter weight as a predetermined value and output a filter weight of a pixel corresponding to an operation target.

The electronic device 800 may train the denoising MLP 220 using a ground-truth (GT) image for training. The GT image may be a high-quality and high-resolution clear image generated by a ray tracing method using thousands to tens of thousands of samples.

In the training process, the difference between the GT image and the final denoised ray tracing image in which all pieces of processing are completed may be calculated using a mean squared error (MSE) loss function (e.g., L2 loss function) or an mean absolute error (MAE) loss function (e.g., L1 loss function), and based on the loss function used, the denoising MLP 220 may be trained in an end-to-end manner.

Additionally, to define the loss function of the denoising MLP 220, downsampling may be performed on the GT image to convert the GT image to a low resolution GT image and downsampling may also be performed on the image of the albedo 201 to convert the image of the albedo 201 to a low resolution image of the albedo 201, so a demodulated image may be generated. The training of the denoising MLP 220 may be further refined by calculating the L1 loss function or the MSE loss function between the demodulated image and the denoised irradiance image (e.g., the second irradiance image 230).

The denoising LUT is a table that pre-calculates and stores an output value corresponding to an input value of an MLP and may be a method of avoiding a complex calculation and obtaining the result quickly by inquiring for the pre-calculated result for each input.

In an example case in which the denoising LUT is used in a parallel computing device such as a GPU, the denoising LUT may quickly obtain a desired result with a memory access. For example, the denoising LUT may quickly obtain the desired result only with the memory access, thereby providing the same effect as the MLP without a complex operation.

According to an embodiment, the electronic device 800 may train the upscaling MLP 240 based on the denoised ray tracing image 260. In an example case in which the training of the upscaling MLP 240 is completed, the electronic device 800 may convert an upscaling filter MLP into an upscaling LUT and store the upscaling LUT. The training processes described above may be trained using a method such as backpropagation.

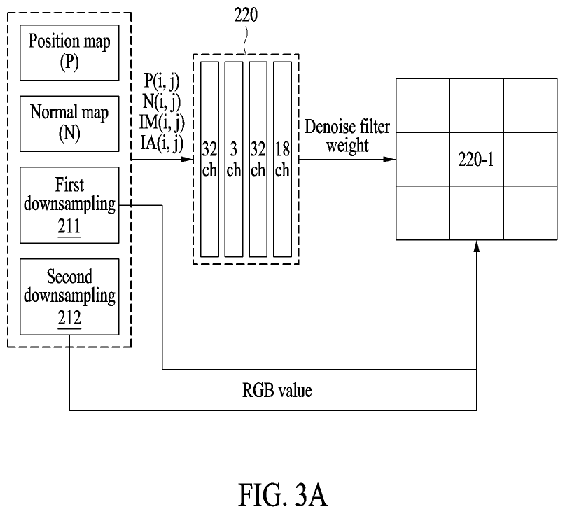

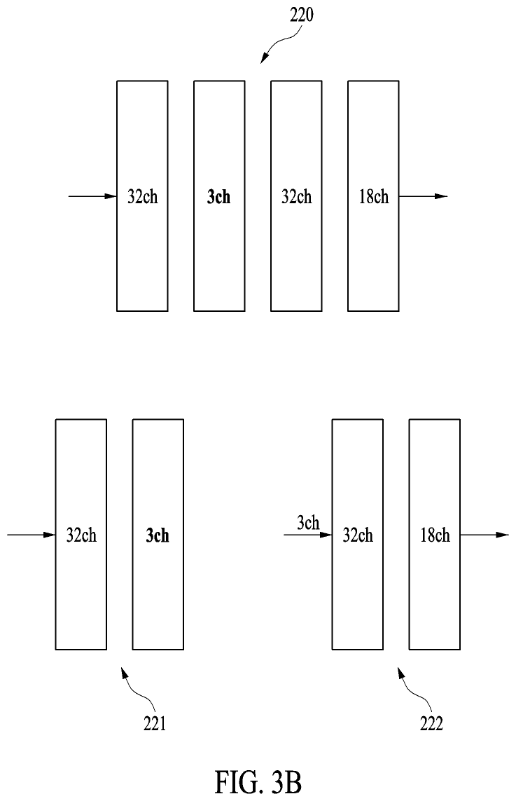

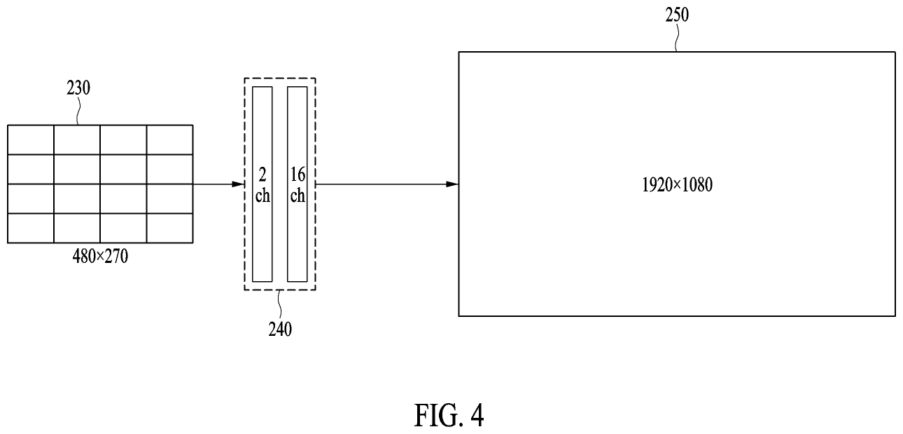

A training process of the denoising MLP 220 and the upscaling MLP 240 is described in detail below with reference to FIGS. 3A, 3B and 4.

FIG. 3A is a schematic block diagram illustrating an operation of a denoising MLP, according to an embodiment.

The description provided with reference to FIGS. 1 and 2 may apply to FIG. 3A, and any repeated description related thereto may be omitted.

Referring to FIG. 3A, the denoising MLP 220 may receive, as inputs, pieces of pixel information P(i, j), N(i, j), IM(i, j), and IA(i, j) and output 18 filter weight parameters.

The pieces of pixel information P(i, j), N(i, j), IM(i, j), and IA(i, j) used as inputs may include a position map P, a normal map N, the first downsampled image 211 (e.g., IR_MAX_POOL, IM), and the second downsampled image 212 (e.g., IR_AVG_POOL, IA). Each input may be individually provided to an initial layer of an MLP, and an operation may be performed based on the corresponding information. The position information may represent a 3D position of a pixel 220-1 corresponding to an operation target, and the normal information may represent a surface normal vector of a corresponding pixel, which may be used to identify the direction and angle in which light touches an object. IM and IA may be down-sampled irradiance images representing a high-frequency frequency component and a low-frequency component, respectively. For example, IM may be the first downsampled image 211 and IA may be the second downsampled image 212.

The denoising MLP 220 may perform a dimension reduction in the first half layer by combining pieces of input information.

Referring to FIG. 3A, in the first half layer, the dimension reduction may be performed to a 3 channel (3 ch) through an operation of 32 channels (32 ch), and through this dimension reduction process, only important features may be left and unnecessary data may be removed. According to an embodiment, the 3 channel (3ch) may refer to a bottleneck feature vector having three output dimensions, and the operation of 32 channels (32ch) may refer to processing through an intermediate hidden layer having 32 units in a fully connected structure. That is, the input feature vector is passed through a 32-channel hidden layer and compressed into a 3-dimensional vector, which serves as a compact representation for subsequent processing. Thereafter, in the second half layer, 18 parameters may be output through the operation of 32ch again, so a filter weight may be calculated in this process. For example, in the second half layer, the compressed 3 ch vector is passed again through a 32-channel layer and transformed into 18 output parameters as illustrated in FIG. 3B. For example, FIG. 3B schematically shows the MLP architecture including a dimension reduction stage (221) and a parameter generation stage (222).

The output 18 parameters may include two pairs of 3×3 weights, and using these weights, the second irradiance image 230 that is finally denoised may be generated by combining the result of the first downsampling 211 with the result of the second downsampling 212. For example, a smoother and less noisy result may be obtained by performing a weighted sum on the RGB values of each pixel in the 3×3 pixel range around the pixel 220-1.

The number of layers of the denoising MLP 220 and the number of channels of the layers are not limited to the illustrated in FIG. 3A. As such, according to another embodiment, the denoising MLP 220 may have a different number of channels. For example, layers having 32ch may have 16 channels or 64 channels depending on the computing environment. Moreover, while the 3×3 surrounding range is an example, the disclosure is not limited thereto, and as such, according to another embodiment, the surrounding range may expand to 4×4, etc.

FIG. 3B is a diagram illustrating a process in which a denoising MLP in which training is completed is divided into a dimension reducer and a denoising LUT and stored, according to an embodiment.

The description provided with reference to FIGS. 1 to 3A may apply to FIG. 3B, and any repeated description related thereto may be omitted.

The denoising MLP 220 may be trained based on the denoised ray tracing image 260.

Referring to FIG. 3B, the layers forming the denoising MLP 220 may be separated into two parts.

A first half MLP 221 in which training is completed may perform a dimension reduction that receives a 12-dimensional input and generates a 3D (or 2D) output. The first half MLP 221 may reduce the dimension of a given input, maintain only necessary core information, reduce remaining unnecessary information, and increase the efficiency of an operation.

For example, the first half MLP 221 may be efficiently processed using a GPU shader. The GPU shader is a parallel computing device specialized in graphics processing and may process repetitive mathematical operations, such as a dimension reduction, extremely quickly. For example, input data, such as position information, normal information, IR_MAX_POOL, and IR_AVG_POOL, may be input to the first half MLP 221, so the load of an operation may be reduced by reducing the dimension to 3D data. Each shader may be configured as a fully fused MLP designed to be implemented and executed at a level that does not exceed the register size. The fully fused MLP may refer to a state optimized not to exceed the data size that may be processed at one time inside the GPU, thereby preventing a bottleneck phenomenon and performing high-speed processing. Accordingly, a structure of the fully fused MLP may be executed in the GPU without any change.

As described above, the electronic device 800 may convert the first half MLP 221 in which training is completed into a dimension reducer and store the dimension reducer.

A second half MLP 222 in which training is completed may receive a 3D input and generate an 18-dimensional output. The second half MLP 222 may output a filter weight and finally output necessary parameters that perform denoising. Since the second half MLP 222 generates the filter weight, the output may be converted into a 3D texture or a 2D texture later.

For example, the electronic device 800 may generate 5 to 6 3D textures (e.g., 5 red, green, blue, and alpha (RGBA) sheets or 6 RGB sheets) of a 32×32×32 resolution and store the 5 to 6 3D textures in batches. The textures may include certain spatial and color information, and here, each 3D texture may have 32 dimension-layers and each layer may have a resolution of 32×32 pixels. The 3D texture may be configured in a form that efficiently stores data from various positions in a space and may be quickly accessed by the GPU if needed.

The 32×32×32 resolution may allow each texture to store information in a 3D space. The storing of the information in the 3D space may refer to storing and managing the information in various dimensions, including 3D data, rather than simply flat data.

In the 5 to 6 3D textures, each texture may represent different properties or channels. In an example case in which the textures are formed of 5 RGBA sheets, each texture may store information about an RGBA channel. In the case of 6 RGB sheets, each texture may include information about each RGB.

The generated textures may be stored in batches in the form of the denoising LUT. Through this, it may be possible to provide a structure capable of accessing all pieces of data at one time or performing operations in parallel. Since the GPU may quickly read and use the textures stored as the denoising LUT, it may be possible to reduce latency in a real-time operation and support fast rendering (or denoising).

The input 3D data may be quantized into 32 stages and stored in the 3D texture. Quantization is a process of dividing data into 32 sections and expressing the data, which may increase data storage efficiency and reduce memory usage during an operation. In an example case in which the original data has consecutive real values from 0 to 1, it may be possible to reduce the storage space and increase the operation speed by dividing the original data into 32 values and expressing the 32 values. Quantized data may be designed to be quickly calculated in the GPU, enabling efficient processing even in a real-time graphics operation.

Interpolation may be applied between quantized values. Since the quantized data is discontinuous, it may be necessary to estimate a natural intermediate value between the quantized values. To this end, interpolation may be used to restore continuity between the quantized values and obtain a natural graphic result.

According to an embodiment, interpolation in the 3D texture may be performed in a 3D space. In an example case in which an input coordinate is positioned between the grid points of a texture, the nearest 8 quantized values may be referenced so that interpolated values between the nearest 8 quantized values may be calculated. Through interpolation, the continuity of the quantized values may be maintained, and changes in illumination or color information may be smoothly expressed.

For example, when training is completed, the electronic device 800 may convert the second half MLP 222 of the denoising MLP 220 into the denoising LUT and store the denoising LUT.

The denoising MLP 220 may be a model that calculates a filter weight based on pixel position, surrounding information, etc. Since the operation may include a mathematical calculation that is complex and has a high operation cost, directly executing the MLP every time in a real-time application may consume a lot of resources and time. Accordingly, by converting the second half MLP 222 of the denoising MLP 220 into the denoising LUT and storing the pre-calculated result, the second half MLP 222 of the denoising MLP 220 may be converted into a form that may be quickly used in a real-time application.

Through the denoising LUT conversion, the output results of the denoising MLP 220 may be pre-calculated and stored in the form of a table. The electronic device 800 may obtain the filter weight immediately by referring to the denoising LUT during a real-time operation and may perform denoising without a complex operation. For example, instead of calculating 18 weights each time according to the input values such as the position map P and normal map N of a pixel, IR_MAX_POOL, and IR_AVG_POOL, pre-calculated weights may be stored in the denoising LUT for immediate reference.

In an example case in which real-time rendering is required, the filter weight for each pixel may be obtained extremely quickly by referring to the denoising LUT. Finally, the electronic device 800 may quickly generate a high-quality image with noise removed.

The denoising LUT conversion may also convert the task of performing a weighted sum on the filter weight based on the pixel position and the information of the surrounding 3×3 pixels into the task of simply referring to a pre-calculated value. Since the calculation of the filter weight is replaced with the reference task of the denoising LUT, it may be possible to obtain a high-quality denoising result while avoiding all the complex operations performed by the denoising MLP 220.

According to an embodiment, by converting the denoising MLP 220 into the dimension reducer and the denoising LUT, the operation efficiency may increase by replacing an operation with a table lookup.

FIG. 4 is a block diagram schematically illustrating an operation of the upscaling MLP 240 in which training is completed, according to an embodiment.

The description provided with reference to FIGS. 1 to 3B may apply to FIG. 4, and any repeated description related thereto may be omitted.

Referring to FIG. 4, the upscaling MLP 240 may receive the second irradiance image 230 and generate the third irradiance image 250 that is upscaled. The upscaling MLP 240 may obtain a clearer and more accurate final output by converting a low-resolution image into a high-resolution image.

Referring to FIG. 4, the second irradiance image 230 with a resolution of 480×270 may be used as an input. An input image may expand to a resolution of 1920×1080 through the upscaling MLP 240. Here, since the resolution increases by 4 times both horizontally and vertically, the upscaling MLP 240 may receive an offset position (dx, dy) of each pixel as an input and estimate 16 upscaling filter weights for the corresponding position. For example, an upscaling filter may be applied by considering the influence of surrounding pixels through offset information at a certain pixel position of an image. Although FIG. 4 illustrates an example in which the resolution increases by 4 times both horizontally and vertically, the disclosure is not limited thereto, and as such, according to another embodiment, the change (or the expansion) in resolution may be different.

The upscaling MLP 240 may finally generate a high-resolution image using information of surrounding 4×4 pixels. That is, the upscaling MLP 240 may calculate an upscaling value by applying the upscaling filter weight based on the surrounding information of each pixel. For example, the upscaling MLP 240 may perform smooth upscaling through a weighted sum using the information of the surrounding 4×4 pixels in a low-resolution input image.

For example, 16 filter weights are values estimated by an MLP through training, so accurate interpolation and filtering may be possible according to the position of each pixel. The offset position may determine where each pixel should be positioned in the final resolution and calculate the upscaling filter weight based on the relative position of each pixel, and the upscaling filter weight may be applied.

The electronic device 800 may obtain the denoised ray tracing image 260 by multiplying the third irradiance image 250 by the original albedo 201. The denoised ray tracing image 260 may become the light intensity information of the final rendered image.

The upscaling MLP 240 may compare the ray tracing image 202 generated during the training process with a GT image and perform training using a loss function such as an MSE or L1 loss. For example, the GT image is high-quality real data, and the upscaling MLP 240 may be trained to reduce the difference from the ray tracing image 202 generated by the upscaling MLP 240. In the training process, the MSE loss function may perform training to average and minimize the square of the error between a predicted value and an actual value in each pixel, and the L1 loss function may perform training by minimizing the absolute error.

When training is completed, the electronic device 800 may convert the upscaling MLP 240 into an upscaling LUT and store the upscaling LUT. The upscaling LUT may refer to the task of converting the upscaling filter weight in which a complex operation and training of the upscaling MLP 240 are completed into a form that may be used quickly. By pre-calculating the output results of the upscaling MLP 240 that is trained and storing the output results in the form of the upscaling LUT, it may be possible to quickly refer to the output results later.

For example, instead of calculating the filter weight for the offset position (dx, dy) of a certain pixel each time, the necessary weight may be obtained by directly referencing the value stored in the upscaling LUT.

In an example case in which an input value is given in the upscaling process, the electronic device 800 may find the input value in the upscaling LUT, immediately obtain the filter weight, and perform upscaling based on this.

In an example case in which upscaling in a high-resolution image must be performed in real time, the rendering latency may be reduced using the upscaling LUT and smooth and uninterrupted upscaling may be implemented.

The electronic device 800 may convert the upscaling MLP 240 that is trained into the upscaling LUT, store the upscaling LUT, and quickly generate the third irradiance image 250 with a high resolution by referencing the upscaling LUT in real time. Through this, the operation efficiency of the entire system may be maximized and excellent performance in real-time graphics rendering may be maintained.

FIG. 5 is a diagram illustrating a process of decomposing an input image into intrinsic images, according to an embodiment.

The description provided with reference to FIGS. 1 to 4 may apply to FIG. 5, and any repeated description related thereto may be omitted.

Referring to FIG. 5, an input image 510 may be expressed as a product of an intrinsic image representing reflectance 511 (e.g., an albedo) and an intrinsic image representing illumination 512 (e.g., irradiance).

Intrinsic image decomposition may be a method of obtaining an efficient and high-quality result by separating a complex component of an image into two components and processing each component separately. The reflectance 511 may represent a unique feature, such as color or materials of a surface of an object, and may be relatively detailed compared to the illumination 512. In contrast, the illumination 512 may represent how light illuminates a scene and may be relatively less detailed compared to the reflectance 511.

A radiance image (e.g., a ray tracing image) may be converted into an irradiance image by demodulating the radiance image into an albedo. For example, radiance may be expressed as a product of the reflectance 511 and the illumination 512. The illumination 512 that is decomposed may mainly include soft components, so the illumination 512 that is decomposed may be sufficiently restored to the original resolution with less data loss even in an example case in which the illumination 512 that is decomposed is processed at a low resolution.

That is, the irradiance image may include relatively smooth components, and the albedo may include detailed information. Accordingly, the quality of the irradiance image may be maintained even in an example case in which the irradiance image is processed at a low resolution, which may enable more accurate illumination processing while reducing the amount of operation through downsampling.

In addition, the problem of a large value range caused by ray tracing noise may be solved by performing downsampling on the irradiance image by separating the irradiance image into a high frequency and a low frequency. The separation for each frequency may help preserve the diffuse feature and the specular feature. For example, the diffuse feature may represent a soft illumination effect, and the specular feature may represent a sharp effect such as the reflection of a surface of an object.

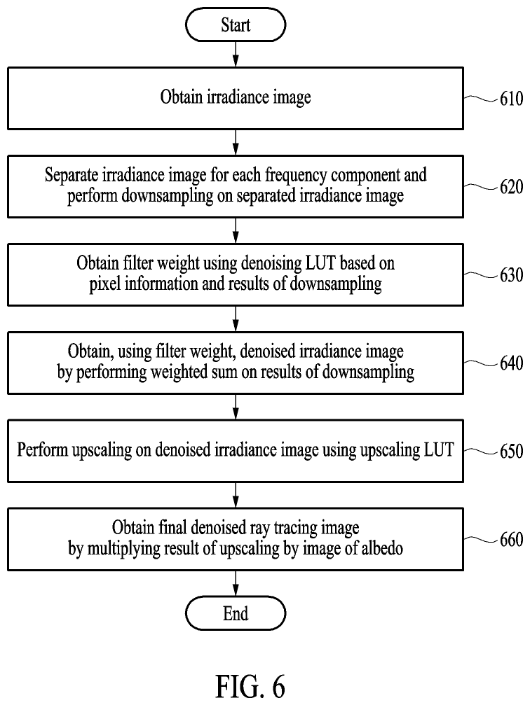

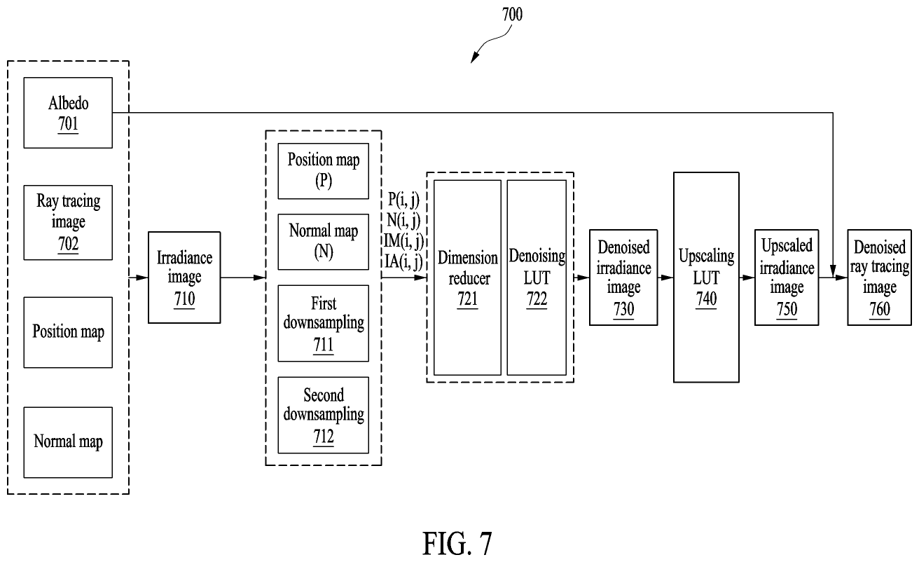

FIG. 6 is a flowchart illustrating a method of denoising a ray tracing image, according to an embodiment. FIG. 7 is a block diagram schematically illustrating an apparatus for denoising a ray tracing image, according to an embodiment.

The description provided with reference to FIGS. 1 to 5 may apply to FIGS. 6 and 7, and any repeated description related thereto may be omitted.

For ease of description, operations 610 to 660 are described as being performed using the electronic device 800 illustrated in FIG. 8. However, operations 610 to 660 may be performed by another suitable electronic device in any suitable system.

Furthermore, the operations of FIG. 6 may be performed in the shown order and manner. However, the order of some operations may change, or some operations may be omitted without departing from the spirit and scope of the shown embodiment. The operations shown in FIG. 6 may be performed in parallel or simultaneously.

Referring to FIGS. 6 and 7, the electronic device 800 may implement a denoising apparatus of a ray tracing image 702 and denoise the ray tracing image 702 during a rendering process. The electronic device 800 may denoise the ray tracing image 702 using a dimension reducer 721 that is pre-trained and converted through the training process described above, a denoising LUT 722, and an upscaling LUT 740.

In operation 610, the method may including obtaining an irradiance image 710 corresponding to a rendering result. For example, the electronic device 800 may obtain an irradiance image 710 by receiving a rendering result.

According to an embodiment, the electronic device 800 may receive inputs, such as an albedo 701, the ray tracing image 702, a position map, a normal map, etc., and generate the irradiance image 710. As described above, the irradiance image 710 may be generated by demodulating the ray tracing image 702 into the albedo 701.

In operation 620, the method may including separating the irradiance image 710 into a plurality of separated irradiance images and performing downsampling on the plurality of separated irradiance images. For example, the electronic device 800 may separate the irradiance image 710 into a plurality of separated irradiance images corresponding to each of the plurality of frequency components and perform downsampling on the plurality of separated irradiance images. The electronic device 800 may perform the downsampling according to a predetermined method. For example, the electronic device 800 may separate the irradiance image 710 into a first separated irradiance image corresponding to a first frequency component and a second separated irradiance image corresponding to a second frequency component. The electronic device 800 may obtain a first downsampled image 711 by perform downsampling on the first separated irradiance image and obtain a second downsampled image 712 by perform downsampling on the second separated irradiance image. For example, the first frequency component may be high-frequency component of the irradiance image 710 and the second frequency component may be low-frequency component of the irradiance image 710.

According to an embodiment, the predetermined method may include a method in which a high-frequency component of the irradiance image 710 generates the first downsampled image 711 using a max-pooling method and a low-frequency component of the irradiance image 710 generates the second downsampled image 712 using an average-pooling method. The first downsampled image 711 may be referred to as a result of the first downsampling or first downsampled information and the second downsampled image 712 may be referred to as a result of the second downsampling or second downsampled information.

Here, the result of the first downsampling (e.g., the first downsampled image 711) may include the high-frequency component, and the result of the second downsampling (e.g., the second downsampled image 712) may include the low-frequency component so that the result of the first downsampling and the result of the second downsampling may maintain the specular feature and the diffuse feature, respectively.

In operation 630, the method may include obtaining a filter weight using the denoising LUT 722 based on pixel information and the results of downsampling (e.g., the first downsampled image and the second downsampled image). For example, the electronic device 800 may obtain a filter weight using the denoising LUT 722 based on pixel information, the first downsampled image and the second downsampled image.

According to an embodiment, the electronic device 800 may obtain the filter weight based on the dimension reducer 721 obtained by performing a conversion on a denoising MLP that is trained by a ray tracing MLP training method and the denoising LUT 722 obtained by performing the conversion on the denoising MLP that is trained by the ray tracing training method.

The position map and normal map information may provide the position and surface information of each pixel, and this may enable an accurate weight calculation required for denoising. The dimension reducer 721 may reduce the dimension of input data and simplify an operation, and the denoising LUT 722 may store a pre-trained weight such that the electronic device 800 may output the filter weight by referring to the denoising LUT 722.

In operation 640, the method may include obtaining, using the filter weight, a denoised irradiance image 730 based on the results of the downsampling. For example, the electronic device 800 may obtain, using the filter weight, a denoised irradiance image 730 by performing a weighted sum on the results of the downsampling.

According to an embodiment, the electronic device 800 may perform an operation on a filter weight for pixels corresponding to operation targets, which are included in the first downsampled image 711 and the second downsampled image 712, and pixels included in a predetermined range around the pixels corresponding to the operation targets.

The electronic device 800 may generate, using the filter weight, the denoised irradiance image 730 by blending the result of the first downsampling 711 and the result of the second downsampling 712. The electronic device 800 may appropriately combine, using each filter weight, each component of a surrounding range of a certain pixel through a weighted sum.

In operation 650, the method may include performing upscaling on the denoised irradiance image 730 using the upscaling LUT 740. For example, the electronic device 800 may perform upscaling on the denoised irradiance image 730 using the upscaling LUT 740 to obtain an upscaled irradiance image 750. For example, since the upscaling LUT 740 stores a pre-trained value from an MLP, the electronic device 800 may obtain an upscaling filter weight that enables a conversion to high resolution by referring to the upscaling LUT 740. The electronic device 800 may perform, using the obtained filter weight, upscaling on the denoised irradiance image 730 with a resolution of 480×270 to a resolution of 1920×1080 and obtain an upscaled irradiance image 750.

In operation 660, the method may include obtain a final denoised ray tracing image 760 based on the upscaled irradiance image 750 and the albedo 701. For example, the electronic device 800 may obtain a final denoised ray tracing image 760 by multiplying the result of upscaling (e.g., the upscaled irradiance image 750) by an image of the albedo 701.

FIG. 8 is a block diagram illustrating an electronic device according to an embodiment.

Referring to FIG. 8, according to an embodiment, the electronic device 800 may include a processor 830, a memory 850, and an output device 870 (e.g., a display). However, the disclosure is not limited thereto, and as such, the electronic device 800 may include one or more other components. The processor 830, the memory 850, and the output device 870 may be connected to each other via a communication bus 805. The electronic device 800 may include, for an operation of the electronic device 800, the processor 830 for performing at least one method described above or an algorithm corresponding to the at least one method.

The output device 870 may display a rendering output result provided by the processor 830. The output device 870 may be the same device as the display included in the electronic device 800. In addition, the output device 870 may be embedded in the electronic device 800 to display the rendering output result or may be an external display device.

The memory 850 may store pieces of data related to the ray tracing denoising MLP training method and the ray tracing image denoising method performed by the processor 830. In addition, the memory 850 may store various pieces of information generated during the processing process of the processor 830 described above. In addition, the memory 850 may store a variety of data and programs. The memory 850 may include a volatile memory or a non-volatile memory. The memory 850 may include a large-capacity storage medium such as a hard disk to store a variety of data.

In addition, the processor 830 may perform at least one method described above with reference to FIGS. 1 to 7 or an algorithm corresponding to the at least one method. In the process described above, the processor 830 may be a hardware-implemented data processing device having a circuit that is physically structured to execute desired operations. For example, the desired operations may include code or instructions included in a program. The processor 830 may be implemented as, for example, a CPU, a GPU, or a NPU. The electronic device 800, which is implemented by hardware, may include, for example, a microprocessor, a CPU, a processor core, a multi-core processor, a multiprocessor, an ASIC, and an FPGA.

The processor 830 may execute a program and control the electronic device 800. Program code to be executed by the processor 830 may be stored in the memory 850.

According to an embodiment, blocks, modules and/or unit described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, a processing device may include a plurality of processors or a processor and a controller. In addition, different processing configurations are possible, such as parallel processors.

Software may include a computer program, a piece of code, an instruction, or combinations thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs or DVDs; magneto-optical media such as floptical disks; and hardware devices that are specially configured to store and perform program instructions, such as read-only memory (ROM), RAM, flash memory, and the like. Examples of program instructions include both machine code, such as produced by a compiler, and files containing higher-level code that may be executed by the computer using an interpreter.

Although the embodiments have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A method of denoising a ray tracing image, the method comprising:
obtaining an irradiance image corresponding to a rendering result;
separating the irradiance image into a plurality of separated irradiance images, each of the plurality of separated irradiance images corresponding to a frequency component, among a plurality of frequency component;
performing downsampling on the plurality of separated irradiance images to obtain a first downsampled irradiance image and a second downsampled irradiance image;
obtaining a filter weight using a denoising look-up table (LUT) based on pixel information, the first downsampled irradiance image and the second downsampled irradiance image;
obtaining, using the filter weight, a denoised irradiance image by performing a weighted sum on the first downsampled irradiance image and the second downsampled irradiance image;
performing upscaling on the denoised irradiance image using an upscaling LUT to obtain an upscaled irradiance image; and
obtaining a final denoised ray tracing image by multiplying the upscaled irradiance image by an albedo image.

2. The method of claim 1, wherein the obtaining of the filter weight comprises obtaining the filter weight based on a dimension reducer obtained by performing a conversion on a denoising multi-layer perceptron (MLP) that is trained by a ray tracing MLP training method and the denoising LUT obtained by performing the conversion on the denoising MLP that is trained by the ray tracing MLP training method.

3. The method of claim 1, wherein the obtaining of the irradiance image comprises demodulating a ray tracing image into an albedo image.

4. The method of claim 1, wherein the first downsampled irradiance image and the second downsampled irradiance image are obtained using a method in which a high-frequency component of the irradiance image generates the first downsampled irradiance image using a max-pooling method and a low-frequency component of the irradiance image generates the second downsampled irradiance image using an average-pooling method.

5. The method of claim 1, wherein the pixel information comprises position map information or normal map information of pixels obtained according to the rendering result.

6. The method of claim 4, wherein the obtaining of the denoised irradiance image comprises performing an operation on the filter weight for pixels corresponding to operation targets, which are comprised in the first downsampled image and the second downsampled image, and pixels comprised in a range around the pixels corresponding to the operation targets.

7. The method of claim 1, wherein the rendering result comprises at least one of an albedo, a ray tracing image, a position map, and a normal map.

8. A training method of ray tracing denoising, the training method comprising:
obtaining a first irradiance image corresponding to a rendering result;
separating the first irradiance image into a plurality of separated first irradiance images, each of the plurality of separated first irradiance images corresponding to a frequency component, among a plurality of frequency component;
performing downsampling on the plurality of separated first irradiance images to obtain a first downsampled irradiance image and a second downsampled irradiance image;
obtaining parameters from a denoising multi-layer perceptron (MLP) based on pixel information, the first downsampled irradiance image and the second downsampled irradiance image;
obtaining, using the parameters, a second irradiance image that is denoised by performing a weighted sum on the first downsampled irradiance image and the second downsampled irradiance image; and
training the denoising MLP using the second irradiance image.

9. The training method of claim 8, wherein the obtaining of the first irradiance image comprises demodulating a ray tracing image into an albedo image.

10. The training method of claim 8, wherein the first downsampled irradiance image and the second downsampled irradiance image are obtained using a method in which a high-frequency component of the first irradiance image generates the first downsampled irradiance image using a max-pooling method and a low-frequency component of the first irradiance image generates the second downsampled irradiance image using an average-pooling method.

11. The training method of claim 8, wherein the denoising MLP comprises a feature bottleneck layer in an intermediate layer.

12. The training method of claim 10, wherein the obtaining of the second irradiance image comprises performing an operation on the parameters corresponding to a filter weight for pixels corresponding to operation targets, which are comprised in the first downsampled image and the second downsampled image, and pixels comprised in a range around the pixels corresponding to the operation targets.

13. The training method of claim 8, further comprising:
obtaining, using an upscaling MLP, a third irradiance image by converting the second irradiance image into a scale of the first irradiance image; and
obtaining a denoised ray tracing image by multiplying the third irradiance image by an albedo image.

14. The training method of claim 13, wherein the training of the denoising MLP using the second irradiance image comprises training the denoising MLP based on the denoised ray tracing image.

15. The training method of claim 8, further comprising:
based on a completion of training of a filter weight by the denoising MLP, dividing the denoising MLP, converting the divided denoising MLP into a dimension reducer and a denoising look-up table (LUT), and storing the dimension reducer and the denoising LUT.

16. The training method of claim 15, wherein
the dimension reducer is configured to reduce a dimension of an input to correspond to the denoising LUT, and
the denoising LUT is configured to store a quantized filter weight and output a filter weight of a pixel corresponding to an operation target.

17. The training method of claim 14, further comprising:
training the upscaling MLP based on the denoised ray tracing image; and
converting the upscaling MLP into an upscaling look-up table (LUT) based on a completion of training of the upscaling MLP and storing the upscaling LUT.

18. An electronic device comprising:
a memory configured to store instructions; and
one or more processors,
wherein, when executed by the one or more processors, the instructions are configured to cause the electronic device to:
obtain an irradiance image corresponding to a rendering result;
separate the irradiance image into a plurality of separated irradiance images, each of the plurality of separated irradiance images corresponding to a frequency component, among a plurality of frequency component;
perform downsampling on the plurality of separated irradiance images to obtain a first downsampled irradiance image and a second downsampled irradiance image;
obtain a filter weight using a denoising look-up table (LUT) based on pixel information, the first downsampled irradiance image and the second downsampled irradiance image;
obtain, using the filter weight, a denoised irradiance image by performing a weighted sum on the first downsampled irradiance image and the second downsampled irradiance image;
perform upscaling on the denoised irradiance image using an upscaling LUT to obtain an upscaled irradiance image; and
obtain a final denoised ray tracing image by multiplying the upscaled irradiance image by an albedo image.

19. The electronic device of claim 18, wherein, when executed by the one or more processors, the instructions are further configured to cause the electronic device to obtain the filter weight based on a dimension reducer obtained by performing a conversion on a denoising multi-layer perceptron (MLP) that is trained by a ray tracing MLP training method and the denoising LUT obtained by performing the conversion on the denoising MLP that is trained by the ray tracing MLP training method.
